(19) United States
(12) Patent Application Publication
(10) Pub. No.: US 2026/0044480 A1
(43) Pub. Date: Feb. 12, 2026

(54) APPLICATION MODERNIZATION THROUGH DATA MODULARIZATION BY USING COMPLEX NETWORKING ANALYSIS

(71) Applicant: International Business Machines Corporation, Armonk, NY (US)

(72) Inventors: Deivson Rayner Teixeira Da Costa, Brasilia (BR); GLAUCO DOS SANTOS REIS, Sao Paulo (BR); Rogerio Cesar Barbosa dos Santos da Silva, Sao Paulo (BR)

(21) Appl. No.: 18/795,685

(22) Filed: Aug. 6, 2024

(51) Int. Cl. G06F 16/22; G06F 11/36

(52) U.S. Cl. CPC G06F 16/22; G06F 11/3636

(57) ABSTRACT

Mechanisms are provided to perform application modernization through data modularization by using complex networking analysis. A static network of a data model is generated comprising nodes for database objects. Use case information is collected for use cases and community detection is performed on the static network to generate communities of database objects. A cohesion index for each community is determined and the use case information is integrated into the static model to generate a dynamic model having use case node(s) and edges representing interactions between the use case with database objects of the static model. A dispersion index is generated for each use case node and, in response to the dispersion index having a predetermined condition, the communities are dynamically optimized based on the cohesion index and the dispersion index to thereby generate a decomposed data model which is used for application modernization and/or migration.

### BACKGROUND

The present application relates generally to an improved data processing apparatus and method and more specifically to an improved computing tool and improved computing tool operations/functionality for performing application modernization through data modularization by using complex networking analysis.

Migration and application evolution present challenges when looked at from the perspective of the data model. The data model is a model that organizes elements of data and standardizes how they relate to one another and to the properties of real-world entities, e.g., a data model may specify that a data element representing an animal is comprised of various elements which represent various characteristics of that animal including size, color, number of legs, whether the animal has a tail, its genus, its species, etc. Data modeling is the software engineering activity directed to generating and applying formal data model descriptions using data modeling techniques.

Application migration involves processes for making applications designed for one computing environment, able to be deployed into a new computing environment. Application modernization, or application evolution, is the process of taking existing applications and adapting them to make use of new tools and techniques to thereby improve the performance of the application or to make these applications compatible with these new tools and techniques. The rise of new technologies, practices, methodologies, and architectural approaches allow organizations to foresee a horizon where they can reduce time to market and to be competitive. However, without a proper application modernization plan, organizations tend to not benefit from the advantages of these new technologies.

Although there are several techniques for migration and modernization of applications, and these topics are not something new, these techniques have a focus on the application layer and seek to optimize the decomposition of systems based on the structures of the software layer, represented by packages, classes, logical structures, and distributed domains.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a computer-implemented method is provided comprising generating a static data model network for a database having a plurality of database objects, where nodes in the static data model network represent corresponding database objects in the plurality of database objects, and a first set of edges in the static data model network represent interdependencies between the plurality of database objects. The computer-implemented method further comprises capturing, during execution of an application that interacts with the database, use case information comprising data descriptive of interactions between the application and the database, and executing a community detection operation on the static data model network to generate a set of communities of database objects based on the nodes and edges of the static data model network. The computer-implemented method also comprises determining a cohesion index for each community of database objects in the set of communities, and integrating the use case information into the static data model network to generate a dynamic data model network having one or more use case nodes and use case edges representing interactions between the use case with database objects. In addition, the computer-implemented method comprises determining a dispersion index for each use case node in the one or more use case nodes and, in response to the dispersion index having a predetermined condition, dynamically optimizing the set of communities based on the cohesion index and the dispersion index to thereby generate a decomposed data model. The computer-implemented method outputs the decomposed data model to perform one of an application modernization or application migration operation.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of a data modularization and networking analysis system in accordance with one illustrative embodiment;

FIG. 3A is an example diagram showing an example of a static data model network with a community feature added to the nodes of the static data model network in accordance with one illustrative embodiment;

FIG. 3B is an example diagram showing an example dynamic data model network in accordance with one illustrative embodiment;

FIG. 3C shows the use case relationship with communities and database model objects in accordance with one illustrative embodiment;

FIG. 3D shows an example iteration for optimizing community identification taking into account use case dispersion in accordance with one illustrative embodiment; and

FIG. 4 presents a flowchart outlining example operations of elements of the present invention with regard to one or more illustrative embodiments.

### DETAILED DESCRIPTION

The illustrative embodiments provide an improved computing tool and improved computing tool operations/functionality for performing application modernization through data modularization by using complex networking analysis and data model analysis. The illustrative embodiments establish an integrated view of the decomposition of complex data models that allows guidance with regard to the function of use cases in the data model and how this relates to the application layer. This provides a bridge between software engineering componentization and practices supported by a vision-based analysis of the structural organization of the data model. Through the creation of a mechanism that can cluster database objects by affinity of usage in relation to use cases, and generating tightly coupled communities that facilitates the visualization and understanding of how database objects are related, the improved computing tool and improved computing tool operations/functionality of the illustrative embodiments can uncover hidden relationships between the data model structures and software engineered model. The results are used in a monolithic application modernization strategy and operations, creating a harmonic decomposition visualization and correlation between the data model and potential microservices for modernizing the application, or for planning and reducing the risk of a complex application migration, e.g., a database migration.

The illustrative embodiments described herein will be presented with reference to database applications and database migration for illustration purposes, but are not limited to such. Moreover, the illustrative embodiments will be described with regard to a microservices based migration/modernization of an existing non-microservices implemented database application, but again are not limited to such. It should be appreciated that the mechanisms of the illustrative embodiments are applicable to any application migration or modernization operations and are not limited to databases or database migration, or to migration/modernization for implementing monolithic applications with a microservices based architecture. The illustrative embodiments provide mechanisms that support application modernization in terms of breaking monolith architectures in small pieces supporting the decomposition of the data model. The illustrative embodiments also support database migration, in order to reduce the risk related with the migration journey, identifying small modules of the database that should be interactively migrated. Moreover, the illustrative embodiments support hybrid cloud modernization, offering guidance of which database components could be packaged together to be consistently moved to the cloud.

Taking the database application as an example, the processes employed to perform database modernization/migration (hereafter collectively referred to as “modernization” for ease of the description) are a key element of the journey of a database application from a monolithic application architecture to a more modern microservices based architecture, for example. A main drawback of prior approaches to database modernization, which again focuses on the software layer and decomposing the software into logical components, is that the various microservices do not satisfy expectations, i.e., speed, flexibility, independent deployments, and the like, of microservices architectures, as the database applications still continue to operate as a monolithic entity even under a microservices architecture. This is because the processes involved do not take into account the data model of the underlying database and its relationship with the software layer. That is, organizations fail in the process of modernization and migration because data is either not consistent across the microservices or the microservices decomposition efforts are concentrated only at the business layer, leading to a large number of decoupled microservices pointing to a monolithic database layer.

The illustrative embodiments provide an improved computing tool and improved computing tool operations/functionality that identifies database objects that need to be banded together into communities of database objects when considering an application modernization/migration. The illustrative embodiments create a dependency model based on complex network theory, and provide mechanisms that apply various algorithms, such as cluster analysis, community detection, and structural metrics analysis, to evaluate the data composition and guide the modernization/migration computer operations based on the dependency model.

For example, the illustrative embodiments comprise mechanisms to create a node list to represent objects from the database static structure, thereby creating a static network. The illustrative embodiments comprise mechanisms to record database interactions associated with a use case, such as a use case provided by a user, and create an enrichment of the static network, thereby creating dynamic network information. The illustrative embodiments then evaluate a dispersion index of the enriched results of the dynamic network information. The illustrative embodiments comprise mechanisms to execute a community identification process on the node list generated from the database static structure and evaluate a community cohesion of identified communities of the database objects. The illustrative embodiments comprise mechanisms to generate a decomposed data model based on the results of the above operations which can be used as input to drive a software modernization strategy and operations. For example, the communities identified by the mechanisms of the illustrative embodiments may be used as the foundation for application modernization to a microservices architecture. Moreover, with regard to a migration operation, since the communities represent a set of database objects tightly coupled, this means that the community may be migrated together. Thus, the decomposed data model and the identified communities may be used to improve and drive application modernization and migration operations.

Hence, in accordance with one or more illustrative embodiments, mechanisms for modularizing software components based on a data model and user interactions (use cases) are provided. These mechanisms may comprise a parser specifically configured to transform a data model into a network composed of nodes and edges representing the interdependency between data model components. These mechanisms further comprise a community detector specifically configured to detect communities in complex networks and capable of identifying the main communities formed by the data model components. These mechanisms further comprise a cohesion assessor specifically configured to assess the cohesion of the communities formed and to optimize the community search engine and guide decision-making regarding the modularization of the software components based on the assessment of the communities.

The mechanisms of the one or more illustrative embodiments may further include a database agent that is specifically configured to capture database user (applications, users, or the like) interactions with the database and detect any operations representing a use case of the underlying data model. In some illustrative embodiments, a network enrichment engine is provided that is specifically configured to enrich the network of nodes by adding to it information from the interactions captured by the database agent. The network enrichment engine may generate a new network relating components of the data model to the use cases in which they are used. The relationships of this new network, referred to herein as the dynamic data model network, may be weighted by the number of times a corresponding data component was accessed during the capture of the database user interactions. The dynamic data model network combines information from static data model dependencies and dynamic interactions from the use cases.

In some illustrative embodiments, mechanisms are provided to assess the cohesion of the communities that combines the information used for community searches with the community information of the dynamic data model network. A dispersion index assessment may then be performed which evaluates how the use case relationship is dispersed off the original community network model. Moreover, in some illustrative embodiments, mechanisms are provided to optimize the dynamic data model network by minimizing the dispersion index which results in improvements on community cohesion towards a migration roadmap that combines functional/use case modularity and low data model interdependency.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an improved computing tool and improved computing tool operations/functionality to evaluate a data model associated with an application, determine relationships between the data model components and application layer components through complex networking analysis and use case information, and generate communities of database objects that may be used as a basis for modernization/migration of the application, e.g., performing modernization/migration operations to move the application from a monolithic implementation to a microservices architecture. The improved computing tool implements mechanism and functionality, such as data modularization and networking analysis system, which cannot be practically performed by human beings either outside of, or with the assistance of, a technical environment, such as a mental process or the like. The improved computing tool provides a practical application of the methodology at least in that the improved computing tool is able to evaluate the data model and its relationships with the software layer modeling to determine how to modernize/migrate the application to more effectively leverage modern technological advancements, such as microservices and the like.

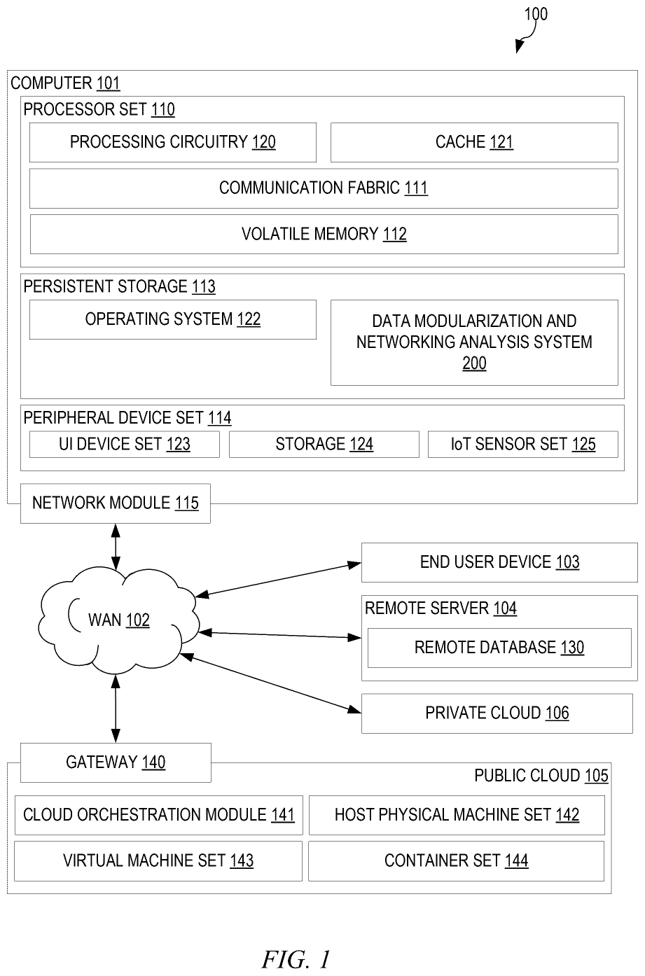

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as data modularization and networking analysis system 200. In addition to data modularization and networking analysis system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data modularization and networking analysis system 200, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in data modularization and networking analysis system 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in data modularization and networking analysis system 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a data modularization and networking analysis system 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates: (1) recording of database interactions associated with a use case and creation of a node list to represent the database objects; (2) executing a community identification operation on the resulting node listing, (3) evaluating community cohesion of the identified communities, (4) enriching the cohesion evaluations with static network information, (5) evaluating the dispersion index; and (6) generating a decomposed data model that can be used as input to drive application modernization strategies and operations and/or assist with migration of the application.

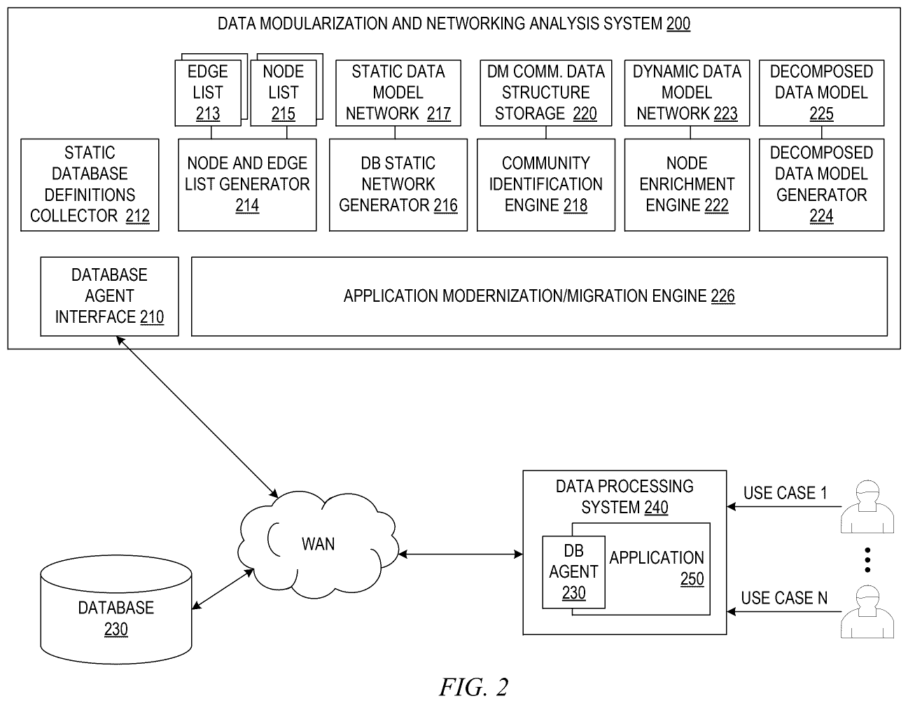

FIG. 2 is an example block diagram illustrating the primary operational components of a data modularization and networking analysis system in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., definitions of use cases, specifications of applications and data models to be evaluated, etc., and the resulting output may aid human beings, e.g., a visualization of the decomposed data model and insights associated with this decomposed data model. The invention is specifically directed to the automatically operating computer components directed to improving the way that application modernization/migration is performed, and provides a specific solution that implements database interaction recording, data model community based analysis, cohesion and dispersion analysis of the data model communities, and decomposition of the data model, which cannot be practically performed by human beings as a mental process and is not directed to organizing any human activity.

As shown in FIG. 2, in accordance with one or more illustrative embodiments, the data modularization and networking analysis system 200 comprises a database agent interface 210, a static database definitions collector 212, a node and edge list generator 214, and a database static network generator 216. In addition, the data modularization and networking analysis system 200 further comprises a community identification engine 218, a data model communities data structure storage 220, a node enrichment engine 222, a decomposed data model generator 224, and application modernization/migration engine 226.

The static database definitions collector 212 is responsible for collecting the static definitions of the data model of the database 260 by creating a list of nodes 215 and a list of edges 213. The collection performed by the static database definitions collector 212 is carried out by a parsing code capable of understanding the structural semantics of the data model in question. In the case of a SQL Model, for example, this definition could be the Data Definition Language (DDL), representing structures such as tables, storage procedures, among other objects of the data model. Once the static database definitions collector 212 has parsed the static definitions of the data model, a second parsing operation is performed by the node and edge list generator 214 to generate the node list 215 and edge list 213 necessary for assembling the static data model network 217. This parsing operation is performed at the beginning of the static data model network 217 generation process and is used to create a static representation of the data model of the database 260. Then the static network generator 216 uses the node list 215 and the edge list 213 to build the network of data model components, i.e., the data model static network 217.

The database agent interface 210 provides a data communication interface, comprising logic, application programming interfaces (APIs), and the like, for communicating with a database agent 230 that may be deployed to a data processing system 240 hosting the application 250 for which modernization/migration is to be performed. One or more users 242-244 may utilize the application 250 which may operate in conjunction with a database 260 to perform various operations. The database agent 230 monitors the interactions between the application 250 and the database 260, throughout the execution of use cases, i.e., sessions of interactions between users and the application 250 and between the application 250 and the database 260, to collect dynamic database interaction information which may then be reported to the data modularization and networking analysis system 200 via the database agent interface 210. This use case data is used to create the relationship between the use case and the data model entities identified in the static data model network, as discussed hereafter.

The community identification engine 216 is a component responsible for applying a community detection algorithm in order to identify groups of nodes that have greater cohesion of relationships between them and, therefore, reduce dependency with other groups of nodes. This process occurs is invoked initially in response to generating the static data model network 217 and then again, by the decomposed data model generator 224 after enriching, by the node enrichment engine 222, the static data model network 217 with the interactions captured by the database agent 230. In this second invoking of the community detection, the community detection is combined with the dispersion index, seeking to identify a community outcome that maximizes cohesion and reduces the dispersion of use cases in relation to communities. All results and simulations of potential identified communities are stored in the data model communities data structure storage 220, allowing comparisons and reviews of the results.

Node enrichment engine 222 is responsible for incorporating the data captured by the database agent 230 into the static data model network 217, creating a new network, referred to as the dynamic data model network 223 that incorporates the dynamic relationship between the static representation of the database with the interactions dynamically captured throughout the interactions with the application 250. This dynamic data model network 223 introduces the dispersion index as a way of measuring how dispersed a use case is depending on the identified communities. A use case that relates to the maximum number of communities in a network is said to have high dispersion, while a use case that only relates to a single community is said to have low dispersion, with other levels of dispersion occurring along the spectrum range between high and low dispersion.

The decomposed data model generator 224 is a component responsible for choosing a best community configuration based on maximizing the cohesion parameters and minimizing the dispersion parameter. The final result, i.e., the decomposed data model 225, is used to guide the migration or modernization process of the application's data model, representing the best componentization of the system.

Thus, in accordance with one or more illustrative embodiments, use cases that are to be used as a basis for componentization of the application 250 are defined. Use cases are, in general, usage scenarios for an application 250 carried out by a user which generates value to the end users 242-244. In general, a use case is defined by an operation that generates a unique value in the application 250. For example, if the application 250 is a mobile banking application, typical use cases may be: (a) make a transfer, (b) pay a bill, (c) invest in an investment, etc. If the application 250 were an e-commerce site, typical use cases may be: (a) performing a search for an item, (b) adding an item to a wish list, (c) updating my profile with a new address, (d) performing a checkout, etc.

As mentioned above, the database agent 230 is responsible for capturing the interactions between the application 250, e.g., a monolithic Java application or the like, and the database 260 throughout the execution of the use cases defined by the users 242-244. In some illustrative embodiments, the database agent 230 may be a Java Database Connectivity (JDBC) agent specifically configured to capture such interactions as use case information, and provide that use case information to the data modularization and networking analysis system 200 via the database agent interface 210. Each use case may be executed in its own individual execution session and the database agent 230 may write the use case information, by associating the collected data with the current execution session identifier information, to one or more use case information data structures (not shown) maintained by the data modularization and networking analysis system 200 for analysis. For example, for each interaction with the database 260 during an execution session between the user 242, 244, the application 250, and the database 260, the database agent 230 captures and writes use case information which includes, but is not limited to, which database object(s) (data structures within a database that store or reference data, e.g., table, view, sequence, index, synonym, etc.) are being accessed and how many times each database object has been accessed. Thus, the use case information stores data describing how the application 250 interacts with the database 260 for the specifically defined use cases at the database object level.

In accordance with one or more illustrative embodiments, the static database definitions collector 212 performs operations to collect from the database 260, the database's Data Definition Language (DDL) information which includes a specification of the procedures and user defined functions for the database 260. The DDL is a standardized language with commands to define the storage groups (stogroups), different structures, and objects in a database. DDL statements create, modify, and remove database objects, such as tables, indexes, and stogroups. The collection from the database may be performed using parsing code that understands the structural semantics of the data model in question.

For each execution session whose use case information is recorded, the node and edge list generator 214 generates an edge list data structure 213 that relates the use case session to the accessed database objects, where the accessed database objects are represented as nodes in a node list data structure 215. Using the database DDL collected by the static database definitions collector 212, the node and edge list generator 214 generates the node listing data structure 215 representing each database object in the database 260 and the use case information may be used to generate the edges in the edge list data structure 213 based on the recorded use case information and the nodes in the node list data structure 215.

In some illustrative embodiments, the edge list data structure 213 and node list data structure 215 may be one or more tabular data representations used as a basis to generate a static data model network 217. In one or more illustrative embodiments, in a node list data structure 215 there is a list of nodes identified by an ID (identification number) and in an edge list data structure 213 there is a list of relationships between pairs of node IDs in the node list data structure 215. These lists 213 and 215 are utilized to create a network, e.g., a graph data structure having nodes and edges connecting nodes. The relationships (edges) between the database objects (e.g., tables, stored functions, user defined functions, indexes, etc.) will have weights depending on the number of accesses performed to the same database object during an execution session, as specified in the use case information collected by the database agent 230.

For example, a node list data structure 215 may be of the type:

TABLE 1
Example Node List Data Structure Table

| Node ID | Name |
|---|---|
| 01 | Table 01 |
| 02 | Table 02 |
| 03 | My Stored Procedure 01 |

Similarly, the edge list data structure 213 may have the following format which specifies the node IDs from the node list data structure 215 that have relationships with each other in a pairwise manner:

TABLE 2
Example Edge List Data Structure Table

| Node ID From | Node ID To |
|---|---|
| 01 | 02 |
| 03 | 01 |
| 03 | 02 |

In this example, there is a network where the object “My Stored Procedure 01” has two relationships, one with Table 01 and one with Table 02. Moreover, there is one relationship between Table 01 and Table 02.

Thus, initially an edge list 213 is generated for the database 260 that specifies each existing relationship between database objects (nodes in node list 215) in the DDL, e.g., relationships between tables, relationships between stored procedures and tables, relationships between stored procedures and user defined functions, etc. There is an edge list 213 and a node list 215 at different points in the operation of the system 200. At a first point, an edge list 213 and node list 215 are generated from the database static representation, e.g., based on the DDL as described above. As described hereafter, at a second point, an edge list 213 and node list 215, or updated edge list and node list, are generated based on the dynamic use case information or data obtained by the database agent 230 from the monitoring of the use case with the application 250 and database 260. This this latter point in the operation, the node list 215 is the list of use cases and the edge list 213 will model the relationship between the use cases with the database objects (nodes in the original node list 215) accessed during the use case interaction.

Based on the initial edge list data structure 213 and node list data structure 215, the database static network generator 216 generates a complex network data structure, referred to as a static data model network 217, representing the data model relationships from the DDL. The term “complex” in the context of network theory refers to structures in network shape (graphs) based on real world representation. In this way, a complex network is much more than a simple graph as it incorporates a non-trivial topology arising from the problem that is modeled. In some cases, it is possible and desired to incorporate some weight into the list of edges 213 of the static data model network 217. In such a case, an attribute is added to the edge list data structure 213 to represent this weight. In the case of an edge list data structure 213 which models the relationship between the use case and the node that represents the database object, the weight is represented by the number of interactions with the database object throughout the use case, for example.

The community identification engine 218 executes a community detection algorithm that identifies the database objects (nodes) of the static data model network 217 that have a greater mutual relationship between each other. In a network, such as the static data model network 217, communities are generated using the edges (relationship) as a primary feature. The community detection algorithm detects groups of nodes that are densely connected. The difference between a weighted network community and non-weighted network community is the value assigned to the edges. In a weighted community the edges will consider the weights of the edges, e.g., in the range from 0.0 to 1.0, whereas in the non-weighted community detection algorithm, each edge will be considered to have the same weight value of 1.

Thus, the communities may be determined by evaluating the proportion of relationships between members of communities. That is, members (database objects) of a community will have a higher proportion of relationships with each other than with other database objects that are not part of the community. This may be determined based on the weights of edges between database objects in the static data model network 217 and one or more thresholds specifying a required weighting or level of relationships between database objects to cluster the database objects into the same cluster or community of database objects. The more cohesive a community is, the higher the proportion of relationships between members of the same community than with members of other communities.

Based on the identified communities, the nodes of the static data model network 217 may be updated with features indicating which community the corresponding database object belongs to. The updated static data model network 217 may be referred to as a data model communities data structure stored in the storage 220. This data model communities data structure may be an updated version of the static data model network 217 with the communities feature of the nodes updated, or it may be a separate data structure that maps each node to a corresponding community identifier such that it identifies which nodes, and their corresponding database objects, are part of the same community.

Once the static data model network 217 is built and the community detection process is applied by community identification engine 218 to generate the data model communities data structure stored in the storage 220, the node enrichment engine 222 may determine the cohesion index of each identified community. To calculate this cohesion index, in accordance with one or more illustrative embodiments, the following formulation is used:

$${CO}_{c} = \frac{{\sum }_{j , i = 1}^{n} {A}_{j , i} {k}_{j}^{c} {k}_{i}^{c}}{{\sum }_{j , i = 1}^{n} {A}_{j , i} {k}_{j}^{c} {k}_{i}^{o u t}} \qquad ( 1 )$$

where CO_{c} is the cohesion index of the community “c”, Aoutj,i is an adjacency matrix of “out” relationships between the nodes of the static data model network 217,

$${k}_{j}^{c}$$

and

$${k}_{i}^{c}$$

are features specifying participation in the community “c” of the node kⱼ and kᵢ where these features have a value of “1” if, and only if, the node belongs to the community “c”, otherwise the value is set to “0”, and the

$${k}_{i}^{out}$$

feature is a value set to “1” if the node kᵢ has a “out” edge pointing to the node kⱼ, and is set to “0” otherwise. The adjacency matrix is a matrix where the rows and columns are the nodes of a network, each cell is an intersection of two nodes, the value of the cell is equal to the value of the relationship between these two nodes. An adjacency matrix is a way of representing a network in matrix form, allowing linear algebra operations, as shown in the equation above.

From the above, it can be seen that the cohesion of a community is given by the total relationships between the members of a community divided by the total relationships of community members with the entire static data model network 217. The cohesion index is used after communities have been formed and serves to quantitatively assess how densely connected communities are. If the cohesion index is equal to 1, it means that a given community is perfectly isolated (members only interact with members of the community itself). If the cohesion index is close to zero, it means that the community is not very cohesive, i.e., the community has a very large number of relationships outside the community. This cohesion index indicator is a way to optimize communities as discussed hereafter.

In addition, the node enrichment engine 222 enriches the static data model network 217 by using the data collected by the database agent 230 during the use case execution sessions to create a new network, referred to as the dynamic data model network (DDMN) 223, where relationships from the execution sessions are included. Use cases are included in the static data model network 217 after communities have been formed and nodes relating to use cases have been added, but the use case nodes do not represent components of the data model. Where the static data model network 217 optimizes communities with only the cohesion index as a parameter for this optimization. The DDMN 223 allows for optimization of the communities to take into account both the cohesion index and a dispersion index, with a goal of maximizing the cohesion index of the communities while minimizing the dispersion index of the communities.

Thus, the node enrichment engine 222 determines a dispersion index for each use case based on the use case information, which includes the edge listing for each use case. The dispersion index measures how much a use case disperses interactions with different database objects of the static data model network 217, which represents the data model of the database 260. That is, the static data model network 217 comprises the nodes and edges for the entirety of the database 260 and the edge lists in the use case information specify the database objects accessed by that use case during the execution session and thus, represents a subset of the nodes and edges in the static data model network 217. The dispersion index measures how much of the static data model network 217 is “touched” by the use case, i.e., how much of the static data model network 217 is accessed during the execution of the use case. The greater the dispersion, the greater the misalignment between the use case with the componentization found in the static data model network 217. For example, if there are 3 communities in a static data model network 217, and a use case depends on these 3 communities, there is a high dispersion rate. This is not desirable for the migration process as it means that the system has functionality that does not allow the monolith to be broken, making the data model modernization or migration process subject to disruption in the application flow. Thus, in the case of a strong dispersion, or high dispersion index, the data model communities identified from the static data model network 217 may be optimized by re-identifying the communities using the coupling of use cases as a complementary feature to the static data model network 217.

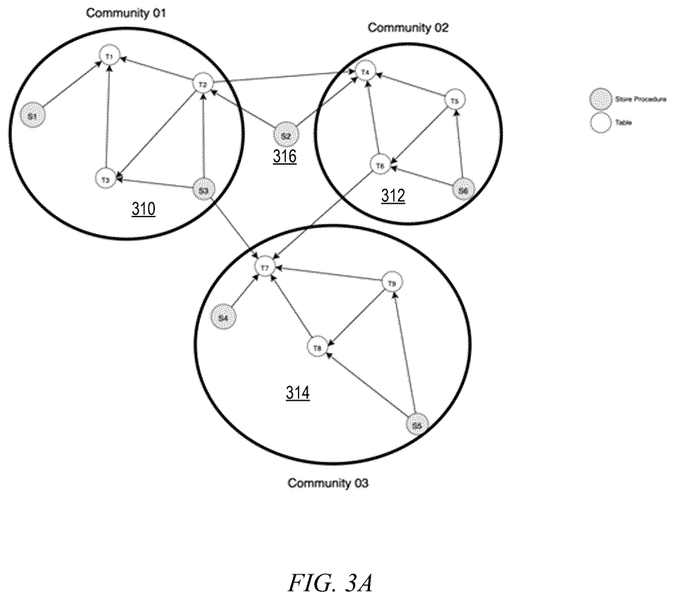

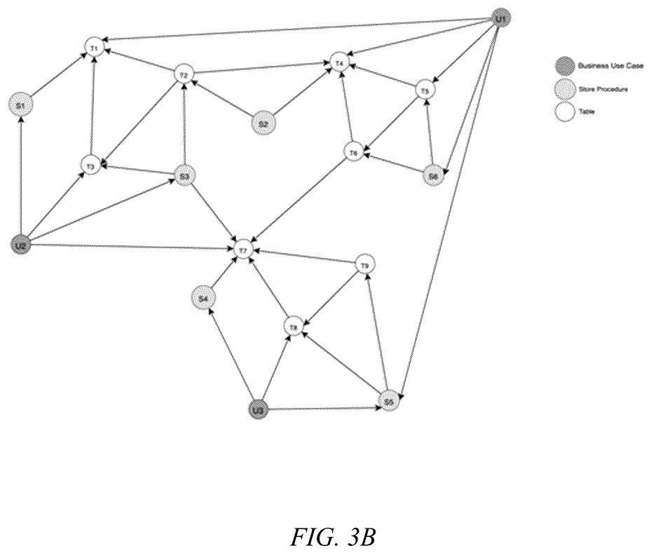

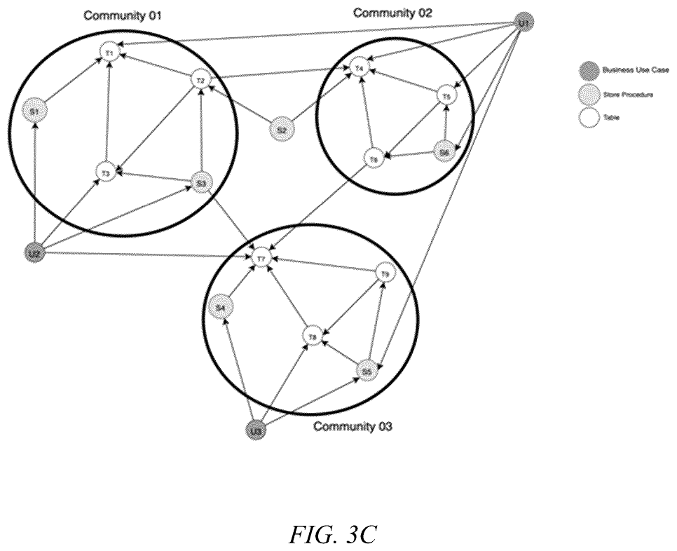

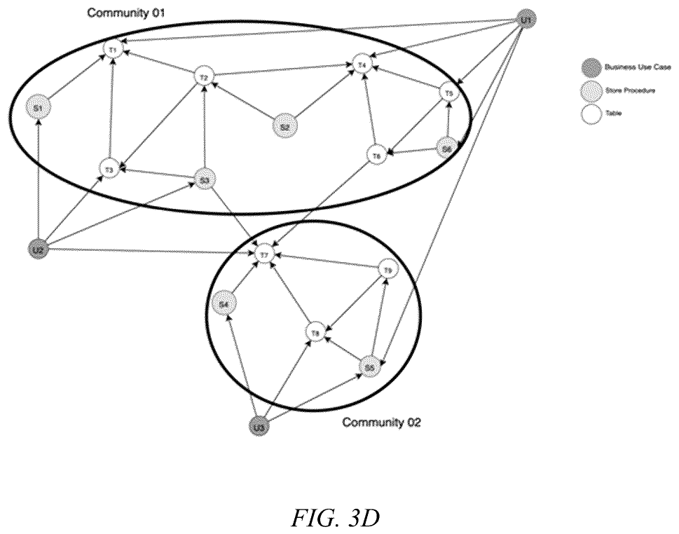

The following is the formulation of the dispersion index in accordance with one illustrative embodiment:

$${D}_{u c} = 1 - ( \frac{{\sum }_{j = 1}^{n} {A}_{j , uc}^{2}}{{( {\sum }_{j = 1}^{n} {A}_{j , uc} )}^{2}} ) \qquad ( 2 )$$

where D_{uc} is the dispersion index of the use case “uc”, and “A_{j,uc}” is an adjacency matrix of adjacency between the nodes of the network use case nodes and communities of database object nodes. That is, the adjacency matrix between the use case nodes and the community database object nodes is a matrix where the rows are the use case nodes and the columns are the communities (see FIG. 3B as an example of a dynamic data model network having use case nodes U1, U2, and U3, and database object nodes). The intersection (the matrix cell) is the number of relationships that exist between the use case node and the database object nodes belonging to the community.

If a use case's dispersion index is high, a new determination of the communities may be generated using the use case nodes as network participants in an updated version of the static data model network 217. That is the nodes in the edge listing for the use case as specified in the use case information may be added to the static data model network 217 to generate an updated static data model network 217 which will then serve as a new basis for performing the community identification by the community identification engine 218. This is done to take into consideration the way in which the use cases interact with the communities of database objects, represented by the static data model network 217 which represents the data model of the database 260, when optimizing the communities for componentization, which is later used for migration and modernization operations.

That is, communities are formed using the database objects from the DDL of the database 260 which are represented in the static data model network 217, since these database objects. The use case adds information to the static data model network 217 and incorporates an additional parameter, i.e., the dispersion index, to optimize the componentization of the model. If the dispersion index is high (within a given threshold of a maximum value, e.g., 1) this means that the number of communities should be reduced. However, when reducing the number of communities, it is important to observe whether there will be a loss of cohesion in the communities. This process is an optimization cycle that is repeated in order to seek a balance between these two parameters. Furthermore, in some illustrative embodiments, an empirical component, e.g., an analyst based on their experience, can decide to penalize a parameter in order to guarantee a desired accommodation of the data model components.

If the dispersion index is not high (e.g., <0.3), and the community has high cohesion (e.g., >0.7), it may not be necessary to modify the communities through optimization, as this may be an expected result in a well-modeled application. These thresholds for determining high/low cohesion and dispersion indices may be set to any desired values depending on the implementation. Each data model can vary in terms of complexity and thus, the migration strategy is a complex empirical component. However, in general implementations will want the dispersion index to be as small as possible, and the cohesion index as bigger as possible.

Once the new communities are determined after integration of the use case nodes to generate the dynamic data model network, the dispersion index of the use case may be revaluated by the node enrichment engine 222 with regard to the dispersion index to determine if there was an improvement or not in the dispersion index of the use case. In addition, the node enrichment engine 222 may evaluate and determine whether there was also an improvement in the cohesion index (see Eq. 1 above) for the updated communities. Based on the changes in the dispersion index and cohesion index, the optimization cycle may be repeated with modifications to the community generation process, or the final community identification may be generated and used to provide modernization/migration guidance. The best balance between the cohesion and dispersion index parameters is sought through this optimization process, with there being a maximum balance. If this maximum balance is achieved, the dynamic data model network will have a data model componentization recommendation that can be used for migration/modernization.

Regression of cohesion and dispersion indicators indicate the need to test different parameters in the community detection process to seek the best possible accommodation for the data componentization model (i.e., high cohesion and low dispersion). Thus, as long as the modeling has not found the best balance between maximizing cohesion and minimizing dispersion, new community rearrangements will be tested until the best balance is reached, i.e., repeating the above described operations until a balance is reached where there is no further appreciable improvement of the cohesion index or dispersion index between iterations of the operations.

Once the balance is achieved, the decomposed data model generator 224 generates the decomposed data model 225 by defining the finally identified communities in quantitative terms based on centrality and structural importance within each community. In complex network theory, structural importance represents a set of metrics that aim to determine how important a node, or a set of nodes (community), is within the network, in this case, the centrality metric plays an important role to define the database objects that are most depended on by other database objects within the same community. Another structural metric is “betweenness”, which identifies the database objects that are most important for communication between communities and therefore, play an important role in the modular interdependence of the entire network. Lastly, the summary of cohesion of each community and dispersion (as represented by the cohesion index and dispersion index) of each use case plays an important role to determine the best balance to improve the componentization arrangement. These data seek to guide the process of migration or modernization of the application, from a data model perspective, within a strategy that respects static modularity (described by the DDL) and dynamics (described by interactions with use cases).

The decomposed data model 225 represents the application 260 by way of a network diagram that decomposes the application 260 into its constituent modules in accordance with the relationships discovered between the application layer and data layers through the mechanisms of the illustrative embodiments. The decomposed data model 225 identifies the main modules that represent optimized suggestions for refactoring the application 260, considering the best balance of cohesion and dispersion parameters as a function of use cases. The decomposed data model 225 may be provided to an application modernization/migration engine 226 for generating a representation of the decomposed data model 225 for guiding authorized personnel involved in the application modernization/migration operations as to the main modules for modernization/migration. In some illustrative embodiments, the decomposed data model 225 may be input to other downstream automated processes to guide these downstream automated processes in perform the modernization/migration operations.

As discussed above, the data modularization and networking analysis system 200 comprises a database static network generator 216 which generates a static data model network 217 from the static database definitions and the node and edge lists generated from these static database definitions. Also as discussed above, to this static data model network 217, the community identification engine 218 adds a feature to the nodes of the network 217 which specifies, for each node, the community to which the node is affiliated. Nodes having the same value for the community feature belong to the same community. This community information may be added to the static data model network 217 or may be added as a separate data model communities data structure stored in the storage 220.

FIG. 3A is an example diagram showing an example of a static data model network with a community feature added to the nodes of the static data model network in accordance with one illustrative embodiment. In FIG. 3A, subsets of the nodes of the network are affiliated with different communities, e.g., community 01, 02, and 03 in this example. It should be appreciated that the static data model would be represented as shown in FIG. 3A without these community designations. In the static data model, the nodes represent the various database objects, e.g., tables (T1, T2, T3, etc.) and store procedures (S1, S2, S3, etc.). The edges of the static data model represent relationships between these database objects, e.g., relationships between tables, relationships between store procedures, relationships between store procedures and tables, etc.

Taking this static data model, the community identification engine 218 identifies communities for the various nodes of the model (or network) as discussed previously. Thus, a first set of nodes 310 are associated with community 01, a second set of nodes 312 are associated with community 02, and a third set of nodes 314 are associated with community 03. It should be appreciated that some nodes may not be affiliated with any communities, e.g., node 316, as their associations with other nodes may not be strong enough to be included in that community. It should be appreciated that there may be a community size requirement, meaning that a particular threshold number of nodes may be required for a new community to be defined.

As mentioned previously, with the illustrative embodiments, a node enrichment is performed by the node enrichment engine 222 based on the identified communities for the nodes of the static data model network 217. This may involve generating and evaluating the community cohesion and the like. This enrichment may involve the generation of a new model (or network), referred to as the dynamic data model network 223 which includes nodes and relationships between use cases and nodes of the static data model network 217. FIG. 3B is an example diagram showing an example dynamic data model network in accordance with one illustrative embodiment.

As shown in FIG. 3B, the dynamic data model network corresponds to the static data model network shown in FIG. 3A but with the addition of use case nodes U1, U2, and U3 and their edges pointing to the nodes in the static data model network which are accessed as part of that use case. Thus, for example, during execution of the use case U1, the execution session accesses tables T1, T4, T5, and store procedure S5. Similarly, use case U2 accesses tables T3 and T3 and store procedures S1 and S3, and use case U3 accesses table T8 and store procedures S4 and S5. This may be determined from the edge list generated for the use case from the use case information collected by the database agent 230 and communicated to the data modularization and networking analysis system 200 via the database agent interface 210. The edges between the use case node and the nodes of the static data model network may be weighted according to the frequency of access of the static data model network nodes during the use case execution.

Thus, the dynamic data model network may update the static data model network with nodes corresponding to use cases, representing the dynamic utilization of the database objects for various use cases. The dynamic data model network may then be analyzed to determine the dispersion index as noted above, which may be used along with the cohesion index to determine a balancing between these metrics when defining and redefining communities of database objects. FIG. 3C shows the use case relationship with communities and database model objects in accordance with one illustrative embodiment. The dynamic data model network, such as shown in FIG. 3B or FIG. 3C may be the basis for performing an update of the community identification, where use case nodes U1, U2, and U3 are added to the network and considered during the update of the community identification. Thus, additional nodes and edges are considered by the community identification engine 218 when redefining the communities of the database objects represented by the nodes.

For example, as shown in FIG. 3D, in a subsequent community identification using the dynamic data model network having the addition of the use case nodes and the weighted edges between use case nodes and the various communities, a new set of communities is identified to try to reduce the general dispersion index, resulting in a reduced number of communities, i.e., the number of communities is reduced from 3 to 2. This is a better solution in terms of componentization of the database system by keeping low dispersion, however the cohesion must also be evaluated to ensure that the cohesion has not dropped below a threshold cohesion.

Thus, the illustrative embodiments provide mechanisms for generating an integrated view of the decomposition of complex data models associated with applications that allows guidance from use cases in generating the decomposition of the combination of the application and data models. This presents a bridge between software engineering componentization and practices supported by a vision-based analysis of the structural organization of the data model. Through the clustering of database objects into communities based on affinity of usage in relation to use cases, these communities facilitate the visualization and understanding of how database objects are related. As a result, previously obfuscated relationships between the data model structures and software engineered model may be identified and used in a monolithic application modernization strategies and operations. This creates a harmonic decomposition visualization and correlation between the data model and potential microservices for modernizing the application, or for planning and reducing the risk of a complex application migration.

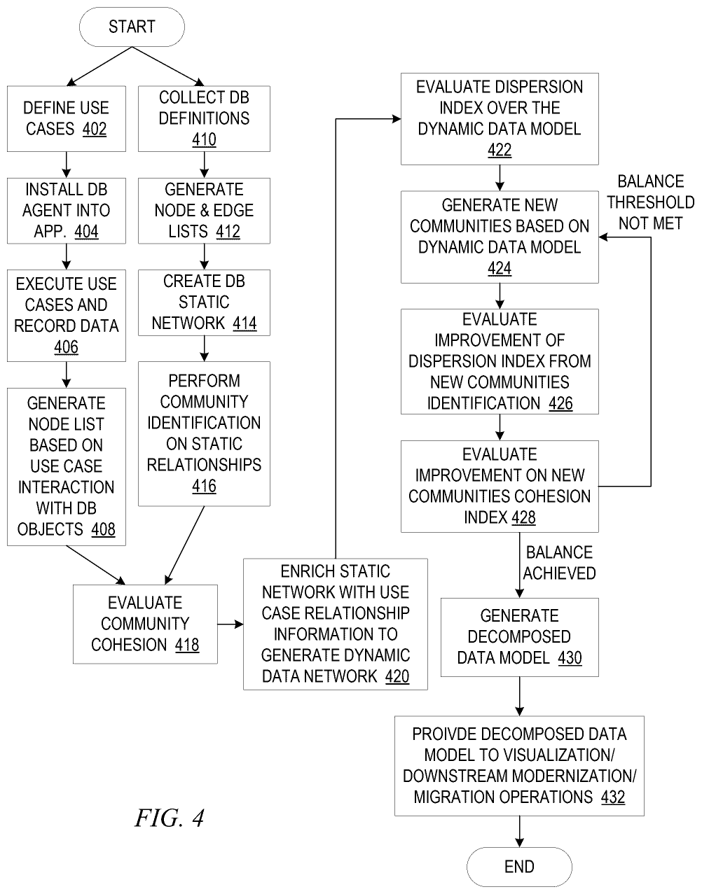

FIG. 4 presents a flowchart outlining example operations of elements of the present invention with regard to one or more illustrative embodiments. It should be appreciated that the operations outlined in FIG. 4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 4, and may, in some cases, make use of the results generated as a consequence of the operations set forth in FIG. 4, the operations in FIG. 4 themselves are specifically performed by the improved computing tool in an automated manner.

As shown in FIG. 4, the operation starts with two paths that may be executed substantially at a same time in parallel paths of execution. In a first path, comprising steps 402-408, use cases are defined that will be used as the basis for componentization (step 402). The use cases represent an atomic function in the application that is the target of the modernization/migration, where the atomic generates something of value for the end user. A database agent is installed into the target application (step 404) and is responsible for capturing the interactions between the target application and the database throughout the execution of the use case. Each use case is executed in a different session in order to record the database interactions (step 406) and thereby generate use case information for the execution session. The collected use case information for the execution sessions of each use case are recorded and a use case edge list is generated relating the use case session to the accessed database objects (step 408). The relationship (edges) in this use case edge list will have a weight depending on the number of accesses performed to the same database object.

In the second path, comprising steps 410-416, the database's DDL definitions of database objects and their relationships is collected (step 410) which may include stored procedures and user defined functions. This database DDL is analyzed to generate a node list representing each database object of the database, and an edge list that represents each existing relationship between database objects specified in the DDL (step 412). Using the node list and edge list, a static data model network is generated (see FIG. 3A) that represents the data model relationships from the DDL (step 414). A community detection algorithm is executed on the static data model network to create a new feature for each node of the static data model network that specifies which community each database object is a member of (step 416). The community detection algorithm identifies the database objects (nodes) of the static data model network that have a greater mutual relationship with each other than with other database objects (nodes) of the static data model network.

Once the static data model network is built, and the community detection process is applied, the cohesion index of each identified community is determined (step 418). The cohesion index may be determined using the formulation in Equation 1, for example. With such a formulation, the cohesion of a community is given by the total relationships between the members of a community divided by the total relationships of community members with the entire static data model network.

The static data model network is enriched by using the data collected during use case sessions (steps 402-408), to generate a dynamic data model network (see FIG. 3B) where relationships from the execution of use cases are included (step 420). The dispersion index (see Equation 2 above as an example) is then determined for the use cases based on the dynamic data model network and static data model network (step 422). As noted above, the dispersion index measures how much a use case disperses interacting with different components of the static data model network. The greater the dispersion, the greater the misalignment between the use case with the componentization found in the static data model network. In a scenario of strong dispersion, the community identification is optimized by recalculating the communities using the coupling of use cases as a complementary feature, i.e., by using the dynamic data model network with the use case nodes added (step 424). step that will be performed in item (8). That is, if a use case's dispersion index is higher than a predetermined threshold, then a new version of the community identification is generated using the use case nodes as network participants.

Thereafter, or if the dispersion index is not higher than the predetermined threshold, it is determined whether the dispersion index was improved by the community reevaluation (step 426). Moreover, the cohesion index of the communities may be evaluated to determine if there was any improvement in the cohesion index as a consequence of redetermining the communities (step 428). These operations may be repeated to search for the best balance between community modularization and use case dispersion. Regression of cohesion and dispersion indicators indicate the need to test different parameters in the community identification process to seek the best possible accommodation for the data componentization model (i.e., high cohesion and low dispersion). Thus, as long as the best balance between maximizing cohesion and minimizing dispersion is not found, i.e., an improvement equal to or above a threshold is no longer achieved, or the indices are not equal to or above/below a predetermined threshold, new community rearrangements will be tested until the best balance is reached. Each time the communities are generated, a change to the hyperparameters of the community detection algorithm is made to try to achieve the optimize balance of cohesion and dispersion, e.g., a hyperparameter that may be adjusted is the number of communities to be generated.

Once the balance is reached, a decomposed data model network is generated by demonstrating the communities identified in the data model (step 430). Again the database objects in the communities are described in the decomposed data model network in quantitative terms based on the community centrality and structural importance of the database objects within each community. The structural importance may be represented as a set of metrics that aim to determine how important a node, or a set of nodes (community), is within the network, e.g., a centrality metric, a betweenness metric, and/or the like. The decomposed data model network may further specify the cohesion of each community and dispersion of each use case that were used to determine the best balance to improve the componentization arrangement. This decomposed data model network may then be provided as output to generate visualization of the decomposed data model for application modernization and/or migration (step 432) and/or provided to a downstream modernization/migration system for implementation of automated or semi-automated modernization/migration operations based on the decomposed data model. Thus, the data model of a monolithic solution, represented by a decomposed data model network, identifying the main modules that represent optimized suggestions for refactoring the data monolith, considering the best balance of cohesion and dispersion parameters as a function of user use cases.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating a static data model network for a database having a plurality of database objects, wherein nodes in the static data model network represent corresponding database objects in the plurality of database objects, and a first set of edges in the static data model network represent interdependencies between the plurality of database objects;
capturing, during execution of an application that interacts with the database, use case information comprising data descriptive of interactions between the application and the database;
executing a community detection operation on the static data model network to generate a set of communities of database objects based on the nodes and edges of the static data model network;
determining a cohesion index for each community of database objects in the set of communities;
integrating the use case information into the static data model network to generate a dynamic data model network having one or more use case nodes and use case edges representing interactions between the use case with database objects;
determining a dispersion index for each use case node in the one or more use case nodes;
in response to the dispersion index having a predetermined condition, dynamically optimizing the set of communities based on the cohesion index and the dispersion index to thereby generate a decomposed data model; and
outputting the decomposed data model to perform one of an application modernization or application migration operation.

2. The computer-implemented method of claim 1, wherein the database objects comprise database objects representing one or more of tables, stored database procedures, or user defined database functions.

3. The computer-implemented method of claim 1, wherein the cohesion index for a community of database objects is based on a first total number of relationships between database objects of the community divided by a second total number of relationships between all database objects of the set of communities of database objects in the data model network.

4. The computer-implemented method of claim 1, wherein the dispersion index for a use case node in the one or more use case nodes and a community in the set of communities is based on a ratio of a first total number of relationships between the use case node and the community, and a second total number of relationships between all use case nodes in the one or more use case nodes and all of the communities in the set of communities.

5. The computer-implemented method of claim 1, wherein for a dispersion index of a use case in the one or more use cases and a community in the one or more communities, the greater the dispersion index, the greater a misalignment between the use case and the community.

6. The computer-implemented method of claim 1, wherein the predetermined condition is the dispersion index being above a threshold dispersion index, and wherein dynamically optimizing the set of communities comprises:
restructuring the set of communities of database objects within the dynamic data model network;
recalculating the cohesion index and the dispersion index based on the restructured set of communities of database objects within the dynamic data model network; and
iteratively repeating the restructuring and recalculating operations until a balance is achieved between the cohesion index and dispersion index.

7. The computer-implemented method of claim 6, wherein iteratively repeating the restructuring and recalculating operations comprises, responsive to a regression in either of the recalculated cohesion index or the recalculated dispersion index, testing different parameters of the community detection operation in order to obtain a highest cohesion index and lowest dispersion index for the restructured set of communities of database objects in the data model network.

8. The computer-implemented method of claim 1, wherein the decomposed data model comprises decomposed data model data specifying particular database objects that have a relatively greatest centrality and structural importance within each community of database objects in a final set of communities in the decomposed data model, particular database objects that are relatively most important for communication between different communities of database objects in the final set of communities, and respective cohesion index values and dispersion index values associated with each use case node in the decomposed data model.

9. The computer-implemented method of claim 1, wherein the static data model network is generated from a database description language (DDL) specification of the database.

10. The computer-implemented method of claim 1, wherein the application modernization or application migration operation comprises a modification of a monolithic application to a microservices infrastructure.

11. A computer program product comprising a computer readable storage medium having a computer readable program stored therein, wherein the computer readable program, when executed in a data processing system, causes the data processing system to:
generate a static data model network for a database having a plurality of database objects, wherein nodes in the static data model network represent corresponding database objects in the plurality of database objects, and a first set of edges in the static data model network represent interdependencies between the plurality of database objects;
capture, during execution of an application that interacts with the database, use case information comprising data descriptive of interactions between the application and the database;
execute a community detection operation on the static data model network to generate a set of communities of database objects based on the nodes and edges of the static data model network;
determine a cohesion index for each community of database objects in the set of communities;
integrate the use case information into the static data model network to generate a dynamic data model network having one or more use case nodes and use case edges representing interactions between the use case with database objects;
determine a dispersion index for each use case node in the one or more use case nodes;
dynamically optimize, in response to the dispersion index having a predetermined condition, the set of communities based on the cohesion index and the dispersion index to thereby generate a decomposed data model; and
output the decomposed data model to perform one of an application modernization or application migration operation.

12. The computer program product of claim 11, wherein the database objects comprise database objects representing one or more of tables, stored database procedures, or user defined database functions.

13. The computer program product of claim 11, wherein the cohesion index for a community of database objects is based on a first total number of relationships between database objects of the community divided by a second total number of relationships between all database objects of the set of communities of database objects in the data model network.

14. The computer program product of claim 11, wherein the dispersion index for a use case node in the one or more use case nodes and a community in the set of communities is based on a ratio of a first total number of relationships between the use case node and the community, and a second total number of relationships between all use case nodes in the one or more use case nodes and all of the communities in the set of communities.

15. The computer program product of claim 11, wherein for a dispersion index of a use case in the one or more use cases and a community in the one or more communities, the greater the dispersion index, the greater a misalignment between the use case and the community.

16. The computer program product of claim 11, wherein the predetermined condition is the dispersion index being above a threshold dispersion index, and wherein dynamically optimizing the set of communities comprises:
restructuring the set of communities of database objects within the dynamic data model network;
recalculating the cohesion index and the dispersion index based on the restructured set of communities of database objects within the dynamic data model network; and
iteratively repeating the restructuring and recalculating operations until a balance is achieved between the cohesion index and dispersion index.

17. The computer program product of claim 16, wherein iteratively repeating the restructuring and recalculating operations comprises, responsive to a regression in either of the recalculated cohesion index or the recalculated dispersion index, testing different parameters of the community detection operation in order to obtain a highest cohesion index and lowest dispersion index for the restructured set of communities of database objects in the data model network.

18. The computer program product of claim 11, wherein the decomposed data model comprises decomposed data model data specifying particular database objects that have a relatively greatest centrality and structural importance within each community of database objects in a final set of communities in the decomposed data model, particular database objects that are relatively most important for communication between different communities of database objects in the final set of communities, and respective cohesion index values and dispersion index values associated with each use case node in the decomposed data model.

19. The computer program product of claim 11, wherein the application modernization or application migration operation comprises a modification of a monolithic application to a microservices infrastructure.

20. An apparatus comprising:
at least one processor; and
at least one memory coupled to the at least one processor, wherein the at least one memory comprises instructions which, when executed by the at least one processor, cause the at least one processor to:
generate a static data model network for a database having a plurality of database objects, wherein nodes in the static data model network represent corresponding database objects in the plurality of database objects, and a first set of edges in the static data model network represent interdependencies between the plurality of database objects;
capture, during execution of an application that interacts with the database, use case information comprising data descriptive of interactions between the application and the database;
execute a community detection operation on the static data model network to generate a set of communities of database objects based on the nodes and edges of the static data model network;
determine a cohesion index for each community of database objects in the set of communities;
integrate the use case information into the static data model network to generate a dynamic data model network having one or more use case nodes and use case edges representing interactions between the use case with database objects;
determine a dispersion index for each use case node in the one or more use case nodes;
dynamically optimize, in response to the dispersion index having a predetermined condition, the set of communities based on the cohesion index and the dispersion index to thereby generate a decomposed data model; and
output the decomposed data model to perform one of an application modernization or application migration operation.
